(19) United States
(12) Patent Application Publication
(10) Pub. No.: US 2003/0183696 A1
(43) Pub. Date: Oct. 2, 2003

(54) Method for processing printed products, printed products produced according to the method, and device for performing the method

(75) Inventors: Konrad Boos, Sirnach (CH); Peter Geiser, Matzingen (CH)

Correspondence Address: Friedrich Kueffner, Suite 910, 317 Madison Avenue, New York, NY, 10017, US

(73) Assignee: Muller Martini Holding AG

(21) Appl. No.: 10/382,718

(22) Filed: Mar. 6, 2003

(30) Foreign Application Priority Data
Mar. 27, 2002 (EP) 02405244.1-2210

(51) Int. Cl. G06K 19/06

(52) U.S. Cl. 235/491

(57) ABSTRACT

In a method for producing printed products of a similar kind in accordance with stored or input data, a machine-readable invisible or visible code for identification purposes is applied onto an outer side of the printed product. The visible code is removed during processing. The finished printed product is free of any visible code that could disrupt the appearance of the printed product.

### BACKGROUND OF THE INVENTION

1. Field of the Invention

The invention relates to a method for producing printed products of a similar kind in accordance with stored or input data, wherein the printed products are provided with a machine-readable code for their identification.

2. Description of the Related Art

The industrial manufacture of similar or identical printed products in printing and processing devices has been known for a long time. Such printed products are, in particular, catalogs or magazines which are produced in very large editions, as is well-known in the art, and then mailed. Such printing and processing devices comprise in their production line, in particular, a collecting device, an adhesive binding device or a stitcher, a trimmer, for example, a three-side cutter, as well as a stacking device.

With such processing devices large editions of identical printed products can be produced which differ, for example, with regard to their labeling and/or their contents and/or their inserts or flyers. Such productions are also known by the term selective binding. The printed products which are collected and combined as desired are designed specifically for the recipient. Individual parts which are irrelevant to the recipient can be removed. For this purpose, a database is required which makes the data relevant for the recipient available in a processed form so that the product to be produced for the recipient is specifically defined.

With a suitable selection of the manufacturing sequence it is even possible to produce the printed products in the sequence in which the mail delivery person places the products into the mailboxes on a clearly defined mail delivery route. Such as sequence is called mailing route-specific. With a corresponding preselection of the data sets and adherence to the sequence during the production, labor with respect to mail distribution is eliminated. These labor savings are made available to the manufacturer in the form of lower postage rates.

Selective binding therefore has particularly the following advantages:

for each recipient a precisely adjusted printed product can be produced;

it is possible to provide inserts or flyers directed specifically to the needs of the recipient;

personal remarks and messages can be printed during the production onto the printed products;

irrelevant parts of the printed products can be eliminated for certain recipients and costs can be reduced in this way;

postage can be saved.

In order for selective binding to be possible, the control device of the processing device must know at any time which printed product is located where within the processing line. If this is not ensured, there is the risk that the printed products are structured wrongly and addressed with the wrong label so that, for example, the magazine for Mr. Miller has the name of Mr. Mayer printed on it. It is understood that such an error must not occur.

Selective binding therefore requires a product sequence. In order to ensure this, it is known to correlate each printed product with a cell of the transport chain. The cells are guided past processing stations, wherein the device control must know the position of the cells and must assume that in each one of the cells the correlated printed product is located. Moreover, it is known to print onto the envelope of the printed products a barcode which identifies the printed product. However, there are many printed products for which a printed barcode is undesirable or disruptive.

### SUMMARY OF THE INVENTION

It is an object of the present invention to provide a method of the aforementioned kind which prevents the aforementioned disadvantages, is functionally reliable, and can be operated inexpensively.

In accordance with the present invention, this is achieved in that the outer side of the printed product is provided with a machine-readable code which is invisible or in that a visible code is printed onto the printed product which is removed during processing. The finished printed product produced in this way thus contains an invisible code or no code at all and can be printed without any restriction on the front and back sides. The graphic design is thus not disrupted by a printed barcode as has been the case in the past.

An especially suitable code according to a further embodiment of the invention is comprised of a plurality of dots which are so small that they are invisible to the eye. However, such dots are machine-readable. These dots can be, for example, in the form of a matrix, preferably a rectangular matrix.

According to another embodiment of the invention, the code is printed by means of invisible ink.

Preferably, such an ink is UV-reflective or IR-reflective. Such inks are not visible or only visible to a limited extent but machine-readable without problems.

According to a further embodiment of the invention, the code is applied with a removable or erasable ink. Such inks are known. They can be removed by heat exposure or by means of a suitable radiation. Coding in this case is also not visible on the finished printed product.

Moreover, the invention relates to a method for producing such printed products as well as to a device for performing such a method.

### BRIEF DESCRIPTION OF THE DRAWING

In the drawing:

FIG. 1 shows schematically a printing and processing device according to the invention; and

FIG. 2 is a printed product which is produced according to the method of the present invention.

### DESCRIPTION OF THE PREFERRED EMBODIMENTS

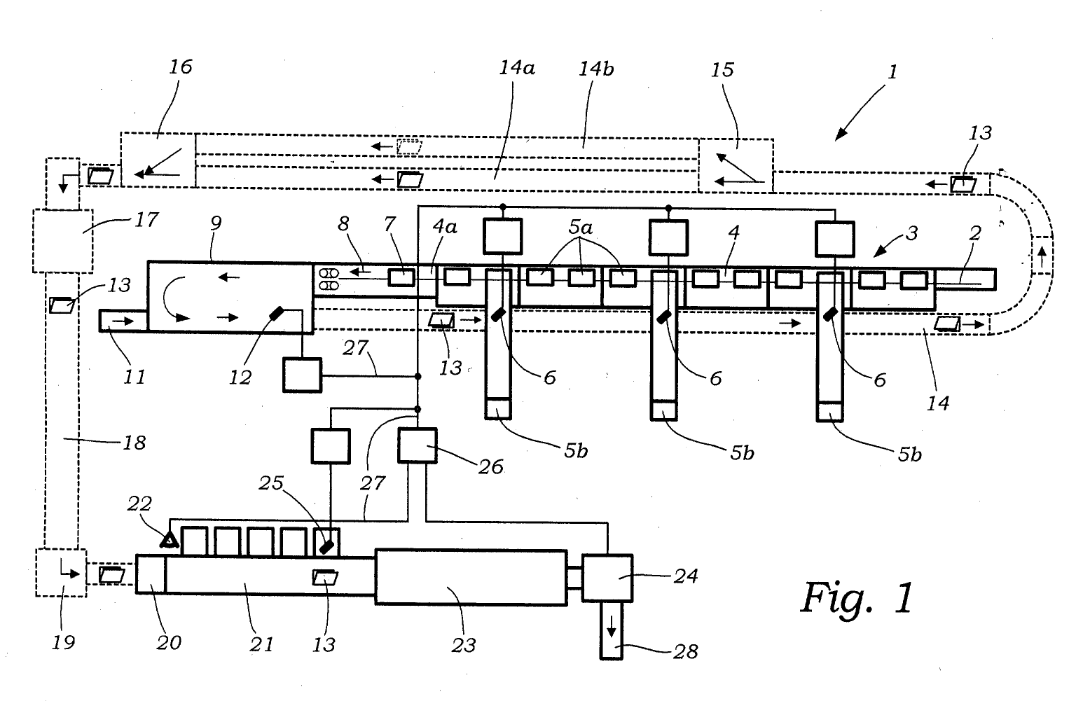

The printing and processing device 1 schematically illustrated in FIG. 1 has a collecting device 3 comprising a collecting channel 4 and several sheet feeders 5 (5a/5b). The sheet feeders 5, known in the art, are arranged along a collecting channel 4. Each one of the sheet feeders 5 is manually or automatically supplied according to the specific needs with the printed sheets. The task of the sheet feeders 5 is to individualize the printed sheets and to feed them in a synchronized fashion onto the chain 2 of the collecting channel 4 comprised of identical sections. For each machine cycle, the collecting chain 2 travels an exact distance along the conveying path. In this way, it is possible that each chain section receives one printed sheet from each sheet feeder 5. By means of a control device 26 controlling operation of the printing and processing device 1, the sheet feeders 5 are activated or deactivated so that at the end 4a of the collecting channel 4 a printed product 7 comprised of the correct number and type of printed sheets has been compiled. Each feeder 5b is preferably provided with an integrated printer 6 that makes it possible to print onto the printed sheet a text which is correlated directly with the corresponding printed product. The printed products can be printed with different texts which are, for example, correlated with the person (recipient) and/or the subject matter. Such a text can be different, for example, for the recipient residing in city A different from that for the recipient residing in city B. The printed pre-product 7 at the end 4a of the collecting chain 4 is, for example, a book block that is not yet bound.

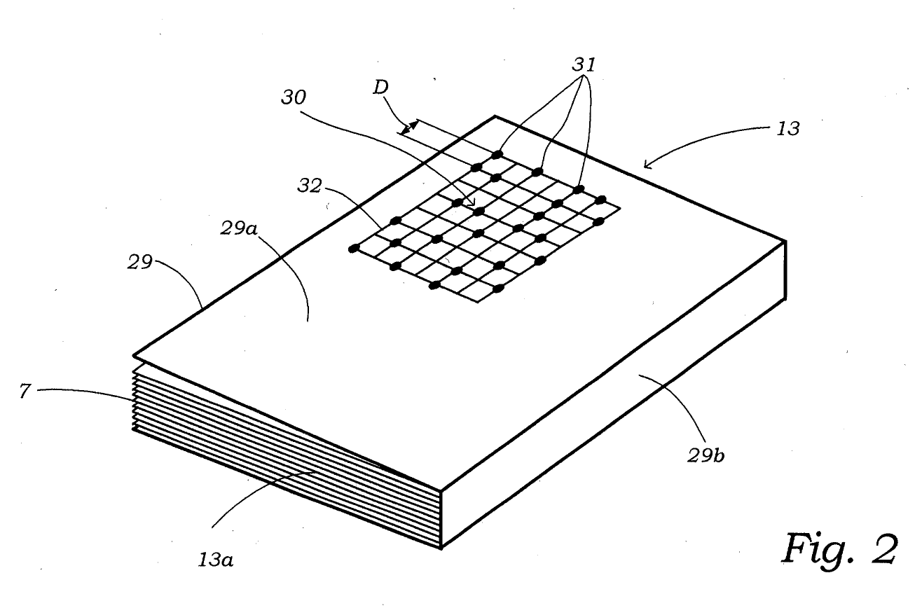

The printed pre-products 7 collected in the collecting device 3 are then transferred in the direction of arrow 8 in synchronized cycled fashion to the adhesive binding device 9. In this adhesive binding device 9 the folds at the back of the printed pre-products 7 are removed by cutting or milling. Subsequently, the spine is prepared by roughing, notching and brushing for the application of the adhesive. After the adhesive has been applied, an envelope 29 (FIG. 2) is pressed by means of an envelope feeder 11 against the spine of the book block or the printed pre-product 7. If it is desired to be able to select during the production process from a selection of different envelopes 29, the use of an envelope feeder 11 with several stations is required. The selection of the matching envelope 29 is realized again by means of the control device 26. At the end of the adhesive binding device 9, a discharge chute can be provided for eliminating faulty products. Up to the end of the binding device 9, the printed pre-products 7 and the printed products 13 provided with an envelope 29 are always correlated with a certain machine cycle and can be identified at any time by the device control 26. In front of the end of the binding device 9 a printer 12 is arranged with which a code 30 can be printed onto the outer side of the envelope 29. According to FIG. 2, the code 30 is comprised of a plurality of dots 31. This code 30 is machine-readable and identifies the printed product 13. In addition, by means of the same printer 12, it is also possible to print text, for example, an address onto the product. The printer 12 is controlled via a control line 27 by the control device 26 which comprises a database for the product-specific data or is connected to such a database. This database contains the product-specific data in processed form. The data are preferably processed according to a manufacturing sequence so that the printed products 13 can be produced in the sequence in which the mailman has to place the products into the mailboxes in accordance with his clearly defined mail delivery route.

The code 30 according to FIG. 2 forms a rectangular dot matrix. The dots 31 are so small that they are not visible or hardly visible by the naked eye. Moreover, the spacings D between neighboring dots 31 of a matrix 32 are several times greater, for example, at least five times greater, than the diameter of the dots 31. In the printed product 13 according to FIG. 2, the dots 31 are printed onto the front side 29a of the envelope 29. The area of the code 30 can be a partial area of the front side 29a or can be the entire area. The code 30 could also be applied onto the spine 29b or onto a cut side 13a. Finally, the code 30 can be printed onto the backside of the envelope 29, not illustrated in FIG. 2. The dots 31 are so small that they cannot be recognized as such as a part of a graphic illustration, for example, a photographic illustration, and therefore do not disrupt this illustration visually. The presence or absence of a dot 31 at an interception of the matrix however can be easily determined by machine reading. Suitable optical readers are known to a person skilled in the art. As an alternative, coding could also be provided by means of ink which intensively reflects particularly UV light or IR light. Such an ink is invisible to the eye but can be machine-read in suitable light. The code 30 could also be printed with an ink which is erasable. Such inks are known. Erasing is realized, for example, by heat exposure. In this case, the code 30 is also invisible on the finished printed product. Finally, the code 30 can also be applied to a foil, not illustrated, such that the code 30 can be removed from the envelope 29.

The printed products 13 provided with the envelope 29 and the code 30 and still warm are transferred to a cooling stretch 14. This cooling stretch 14 is comprised for reasons of simplification and cost reduction preferably of several transport belts, not illustrated. Moreover, the cooling stretch 14 can be comprised over portions thereof of parallel sections 14a, 14b which at the beginning and the end are provided with switches 15 and 16. The purpose of such a two-track partial stretch is that during a disruption-free production all products can be transported via the section 14a while the second section 14b is not used (empty). When in the area downstream of the switch 16 a disruption occurs which causes the transport belts to stop, the sections 14a and the collector 3 are stopped and all printed products 13 which still arrive in front of the switch 15 are then guided onto the still empty stretch 14b. The receiving capacity of the section 14b must be at least so large that the entire contents of the adhesive binding device 9 can be received therein. In this way, it can be prevented that the binding device 9 filled with pre-products 7 must be stopped.

It is important that the printed products 13 in the area of the cooling stretch 14 are provided with the above-mentioned code 30. Even in the case of disruptions or other irregularities in the area of the cooling stretch 14, each printed product 13 can be identified by means of the code 30. It is not possible for the control device 26 to control the printed products 13 in the area of the cooling stretch 14. It is also impossible to recognize whether a printed product 13 in the area of the cooling stretch 14 has been removed and is thus missing. Also, the device control 26 is not capable of detecting switching of two printed products 13.

Downstream of the cooling stretch 14 the printed products 13 are then trimmed in a trimmer 17. This trimming device 17 is particularly embodied as a three-side cutter which cuts the printed products 13 on three open sides. The actual finishing process is thus complete.

Downstream of the cutting device 17 the printed products 13 are supplied on a transport belt 18 to a stacking device 19 in which the printed products 13 are stacked and turned by 90 degrees. In a removing device 20 the printed products 13 are subsequently removed from the stack and then supplied to an insertion device 21. At the same time, the codes 30 of the printed products 13 are read by a reading device which is connected by a control line 27 to the control device 26. The insertion machine 21 now adds to the printed products 13, based on the address of the recipient, an insert or flyer, not illustrated. Since the printed products 13 can be identified by means of the code 30 via the control device 26 and the reading device 22, different inserts, or no inserts at all, can be added in accordance with the data of the recipient. The printed product 13 for Mr. Miller, for example, can receive the insert A and the printed product 13 for Mr. Mayer can receive the insert B. Subsequently, the printed products 13 are then printed by means of a printer 25, also controlled via the control line 27 connected to the control device 26, with the correct address.

Subsequently, the printed products 13 can be wrapped in foil by a wrapping machine 23 and then transferred to a stacker 24. By means of a belt 28, the mailing-ready stacked products 13 are discharged. These stacks of the printed products 13 are preferably arranged in the order of the mail delivery route. Such a stack contains, for example, all printed products 13 which are to be placed into the mailboxes by the mailman on his clearly defined route.

While specific embodiments of the invention have been shown and described in detail to illustrate the inventive principles, it will be understood that the invention may be embodied otherwise without departing from such principles.

What is claimed is:

1. A method for producing printed products of a similar kind in accordance with stored or input data, the method comprising the step of:
applying a machine-readable invisible or a machine-readable visible code for identification purposes on an outer side of a printed product, wherein the visible code is removed during processing.

2. The method according to claim 1, wherein the code is comprised of dots so small that the dots are invisible.

3. The method according to claim 2, wherein the code is a dot matrix.

4. The method according to claim 3, wherein the dot matrix is rectangular.

5. The method according to claim 3, wherein a ratio of a distance between the dots and a diameter of the dots is at least 5.

6. The method according to claim 1, wherein the code is made of a invisible ink.

7. The method according to claim 6, wherein the ink is UV-reflective or infrared-reflective.

8. The method according to claim 1, wherein the code is applied onto a flat outer side, a spine or a cut side of the printed product.

9. A printed product produced according to the method of claim 1, having an invisible code identifying the printed product.

10. The printed product according to claim 9, wherein the code is a dot matrix.

11. A device for performing the method according to claim 1, comprising:
a database containing product-specific data;
a device for applying an invisible code onto the printed products; and
at least one device for reading the code.
